(19) United States
(12) Patent Application Publication
(10) Pub. No.: US 2020/0412004 A1
(43) Pub. Date: Dec. 31, 2020

(54) Antenna and Electronic Device Using Same

(71) Applicant: AAC Technologies Pte. Ltd., Singapore City (SG)

(72) Inventors: Si Chen, Shenzhen (CN); Jing Wu, Shenzhen (CN)

(21) Appl. No.: 16/995,845

(22) Filed: Aug. 18, 2020

Related U.S. Application Data
(63) Continuation of application No. PCT/CN2019/093993, filed on Jun. 29, 2019.

(51) Int. Cl. H01Q 13/28; H04B 3/52; H04B 3/56; H01Q 19/08

(52) U.S. Cl. CPC H01Q 13/28; H01Q 19/08; H04B 3/56; H04B 3/52

(57) ABSTRACT

The invention discloses an antenna including a radiation part and a grounding sheet arranged on top of each other and a radiation part feeding the radiation part. The radiators are spaced apart from each other to form a first gap and a second gap. A feeding part has a first feeding pin, a first feeding arm, a second feeding pin and a second feeding arm. A front projection of the first feeding arm on the plane array is located in the first gap, a front projection of the second feeding arm on the plane array is located in the second gap. And the first feeding arm and the second feeding arm are respectively used for coupling and feeding the four radiators.

### FIELD OF THE PRESENT DISCLOSURE

The invention relates to the technical field of communication, in particular to an antenna and an electronic device using such an antenna.

### DESCRIPTION OF RELATED ART

The fifth generation mobile communication technology will greatly change people's existing way of life and promote the continuous development of society. In order to adapt to the high speed, low latency, high capacity and other technical characteristics of the future 5G, the base station antenna will also use more large-scale antenna array, which also put forward higher requirements for antenna array, antenna which can cover multiple bands will be greatly advocated. The existing antenna covers a lower frequency band.

Therefore, it is necessary to provide a wideband antenna to solve the above problem.

### SUMMARY OF THEN INVENTION

One of the main objects of the invention is to provide a wideband antenna and an electronic device having such an antenna.

Accordingly, the invention provides an antenna, comprising: a radiation part having four radiators distributed in a 2×2 plane array, the radiators being spaced apart from each other for forming a first gap and a second gap perpendicular to the first gap at a center of the plane array; a grounding sheet stacked on the radiation part; a radiation part feeding the radiation part; a feeding part comprising a first feeding pin, a first feeding arm, a second feeding pin and a second feeding arm; a front projection of the first feeding arm on the plane array located in the first gap; and a front projection of the second feeding arm on the plane array located in the second gap. The second feeding arm is perpendicular to the first feeding arm; the first feeding pin is vertically connected with one end of the first feeding arm, and the second feeding pin is vertically connected with one end of the second feeding arm; the first feeding arm and the second feeding arm are respectively used for coupling and feeding the four radiators.

In addition, the first feeding arm is located in a plane where the plane array is located, and the second feeding arm is located in a plane between the plane array and the grounding sheet.

In addition, the first feeding pin comprises a second probe part connected with the first feeding arm and a first probe part connected in series with the second probe part; a diameter of the first probe part is larger than that of the second probe part, the feeding part further comprises at least one first feeding tray, and the at least one first feeding trays is annularly arranged on the second probe part and parallel to the first feeding arm.

In addition, the first feeding trays comprises a plurality of feeding trays spaced from each other.

In addition, the first feeding trays comprise four feeding trays.

In addition, the second feeding pin comprises a fourth probe part connected with the second feeding arm and a third probe part connected in series with the fourth probe part; a diameter of the third probe part is larger than that of the fourth probe part; the feeding part further comprises at least one second feeding tray, and the at least one second feeding tray is annularly arranged on the fourth probe part and parallel to the second feeding arm.

In addition, the second feeding trays comprise a plurality of feeding trays spaced from each other.

In addition, the antenna further comprises a substrate, the radiation part and the grounding sheet are respectively arranged on two opposite surfaces of the substrate; the first feeding pin, the second feeding pin is arranged threaded in the substrate.

In addition, the antenna further comprises a plurality of metal through holes, wherein each of the radiators is electrically connected with the grounding sheet through at least one metal through hole.

The invention further provides an electronic device, comprising an antenna as described above, wherein the electronic device is an intelligent terminal or an antenna base station.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isomeric view of an antenna in accordance with an exemplary embodiment of the present invention;

FIG. 2 is a partially exploded view of the antenna in FIG. 1;

FIG. 3 is an illustration of a radiation part of the antenna;

FIG. 4 is an isometric view of a feeding part of the antenna;

FIG. 5 is an isometric view of a first feeding assembly of the antenna;

FIG. 6 is an exploded view of the first feeding assembly in FIG. 5;

FIG. 7 is a top view of the radiation part, the first feeding assembly and the second feeding assembly of the antenna;

FIG. 8 is an exploded view of a second feeding assembly of the antenna;

FIG. 9 is an exploded view of a substrate of the antenna;

FIG. 10 is a S-curve of the antenna of the present invention;

FIG. 11A is a direction view of horizontal polarization of the antenna in the plane Phi=0°;

FIG. 11B is a direction view of horizontal polarization of the antenna in the plane Phi=90°;

FIG. 11C is a direction view of vertical polarization of the antenna in the plane Phi=0°;

FIG. 11D is a direction view of vertical polarization of the antenna in the plane Phi=90°.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiments described hereby is only to explain the disclosure, not intended to limit the disclosure.

The terms first, second, third, fourth, and the like (if present) in the specification and claims of the present invention and the foregoing drawings are intended to distinguish like objects and are not necessarily intended to describe a particular order or sequence. It should be understood that the data so used can be interchanged at appropriate situation so that the embodiment described herein can be implemented in an order other than what is illustrated or described here. In addition, the terms “include” and “have” and any of their variations are intended to cover non-exclusive inclusion, for example, a process, method, system, product or device that contains a series of steps or units need not be limited to those steps or units that are clearly listed, but may include those that are not clearly listed or for those processes, methods, products Other steps or units inherent in products or equipment.

It should be noted that the descriptions referring to “first,” “second,” and the like in the present invention are for descriptive purposes only and are not to be construed as indicating or implying their relative importance or impliedly indicating the number of indicated technical features. Thus, a feature defined as “first” or “second” may include at least one such feature, either explicitly or implicitly. In addition, the technical scheme between embodiments can be combined with each other, but it must be based on the realization by the person of ordinary skill in the art, when the combination of the technical scheme is contradictory or cannot be realized, it should be considered that the combination of the technical scheme does not exist and is not within the scope of protection required by the invention.

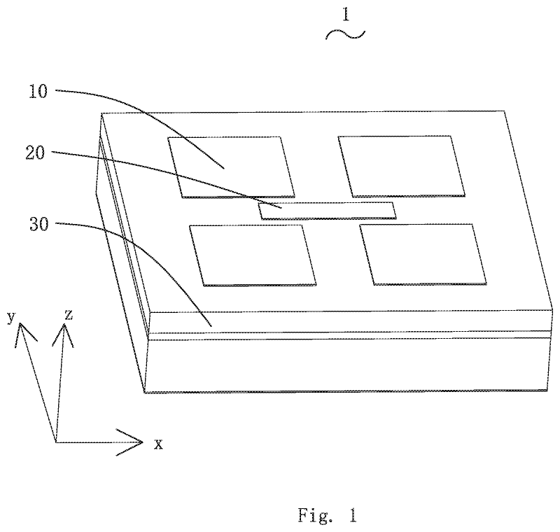

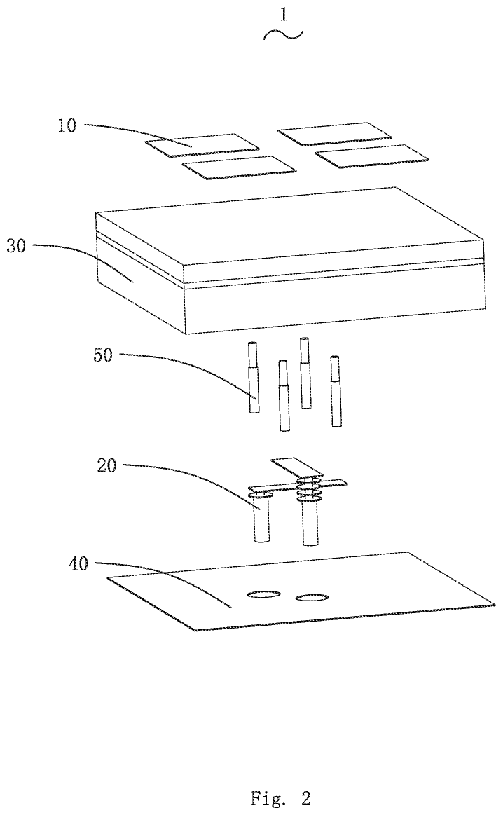

Referring to both FIGS. 1 and 2, the present invention provides an antenna 1, the antenna 1 comprises a radiation part 10, a feeding part 20, a substrate 30, a grounding sheet 40 and a metal through hole 50. The radiation part, substrate 30 and grounding sheet 40 are arranged on top of each other in order, the metal through hole 50 is arranged threaded in the substrate 30, a part of the feeding part 20 is arranged in the substrate 30. The feeding part is used to couple and feed the radiation part 10, it is electrically connected with the grounding sheet 40 through the metal through hole 50 to ground the radiation part.

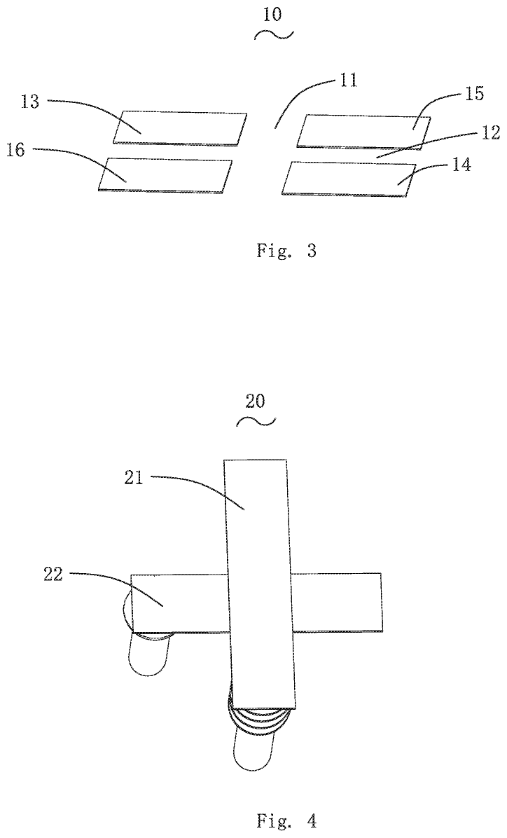

Referring to FIG. 3, the radiation part 10 comprises four radiators arranged in a 2×2 plane array, the radiators are spaced apart from each other to form a first gap 11 and a second gap 12 perpendicular to each other at the center of the plane array. The four radiators are named the first radiator 13, the second radiator 14, the third radiator 15, and the fourth radiator 16 to distinguish them for easier description. The first radiator 13, the second radiator 14, the third radiator 15, and the fourth radiator 16 are provided on the same surface on the substrate 30. In the present embodiment, the first radiator 13, the second radiator 14, the third radiator 15, and the fourth radiator 16 are provided on the surface of the substrate 30 away from the grounding sheet 40. Between the first radiator 13 and the third radiator 15 is the first gap 11, and between the second radiator 14 and the fourth radiator 16 is also the first gap 11; between the first radiator 13 and the fourth radiator 16 is the second gap 12, and between the second radiator 14 and the third radiator 15 is also the second gap 12.

The grounding sheet 40 is used for grounding. The grounding sheet 40 and the radiation part 10 are respectively provided on the two opposite surfaces of the substrate 30. Holes may be provided in the grounding sheet 40 for the feeding part to pass through.

The structure of the metal through hole 50 is not limited, as long as it can electrically connect the radiator and the grounding sheet 40. For example, the metal through hole 50 can be a hollow metal column, a solid metal column, or a wire. Each radiator is electrically connected with the grounding sheet 40 through at least one metal through hole 50. In this embodiment, the metal through hole 50 is a solid metal column, and each radiator is electrically connected with the grounding sheet 40 through one metal through hole 50.

Referring to FIG. 4, the feeding part 20 comprises a first feeding assembly 21 and a second feeding assembly 22, the first feeding assembly 21 and the second feeding assembly 22 couple and feed four radiators respectively. The radiation part 10 forms orthogonal horizontal and vertical polarization under the coupling feed of the first feeding assembly 21 and the second feeding assembly 22.

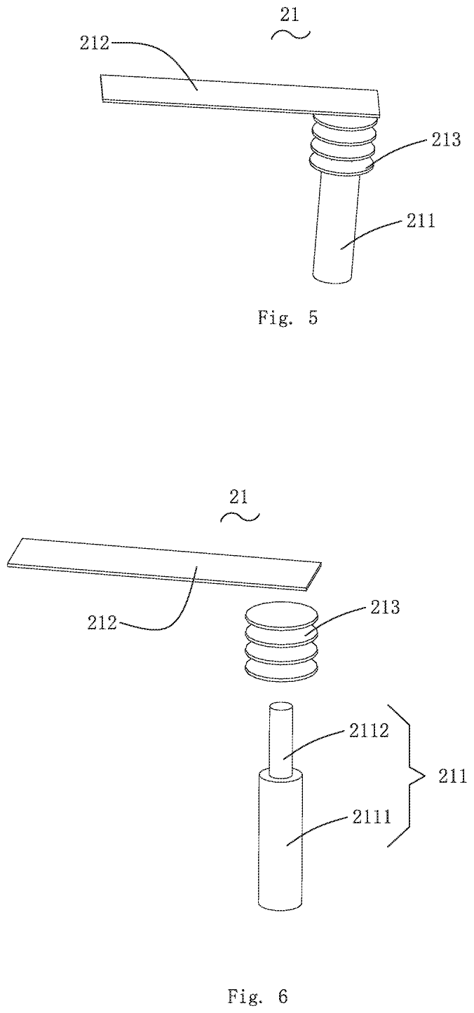

Referring to FIGS. 5, 6, and 7 together, the first feeding assembly 21 comprises a first feeding pin 211, a first feeding arm 212, and a first feeding trays 213. The first feeding pin 211 is electrically connected with the external radio frequency front end, the first feeding arm 212, and the first feeding trays 213, respectively. The front projection of the first feeding arm 212 on a plane array is located in the first gap 11. The first feeding arm 212 is used to couple and feed the four radiators.

The first feeding trays 213 are annularly arranged at the first feeding pin 211 and provided in parallel with the first feeding arm 212. The first feeding trays 213 are flaky. The first feeding trays 213 are in a circular shape in this embodiment. The first feeding trays 213 have at least one feeding trays. At least one of the first feeding trays 213 is/are annularly arranged at that first feeding pin 211, the first feeding trays 213 and the first feeding pin 211 are electrically connected and fixedly connected. The axial direction of the first feeding pin 211 is perpendicular to each of the first feeding trays 213. When the first feeding trays 213 comprise a plurality of the first feeding trays, the plurality of the first feeding trays 213 are spaced. In the present embodiment, the first feeding trays 213 comprise four feeding trays, four first feeding trays 213 are annularly arranged on the first feeding pin 211, and the four first feeding trays 213 and the first feeding pin 211 are electrically connected. The four first feeding trays 213 are provided spaced apart on the first feeding pin 211.

The first feeding pin 211 is vertically connected with one end of the first feeding arm 212. The first feeding pin 211 comprises a second probe part 2112 connected with the first feeding arm 212 and a first probe part 2111 serially connected with the second probe part 2112. Both the first probe part 2111 and the second probe part 2112 are cylindrical, and the diameter of the first probe part 2111 is larger than that of the second probe part 2112. At least one first feeding tray 213 is annularly arranged on that second probe part 2112, and the first feeding tray 213 and the second probe part 2112 are electrically and fixedly connected. The first probe part 2111 is electrically connected with the external RF front end, and the second probe part 2112 is electrically connected with the first feeding arm 212. In this embodiment, the second probe part 2112 is connected with one end of the first feeding arm 212.

The first feeding arm 212 is in a sheet shape, and the first feeding arm 212 is rectangular in shape. In this embodiment, the first feeding arm 212 and the four radiators are located in the same plane, that is, the first feeding arm 212 is located in the plane of the plane array. The first feeding arm 212 comprises opposite first and second ends. A first end of the first feeding arm 212 is located between the first radiator 13 and the third radiator 15, and a second end of the first feeding arm 212 is located between the second radiator 14 and the fourth radiator 16.

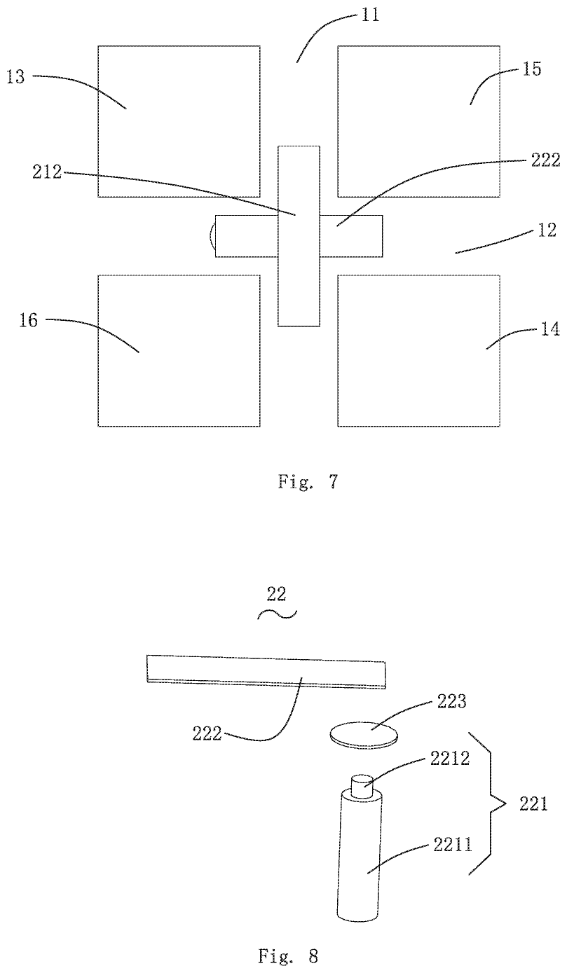

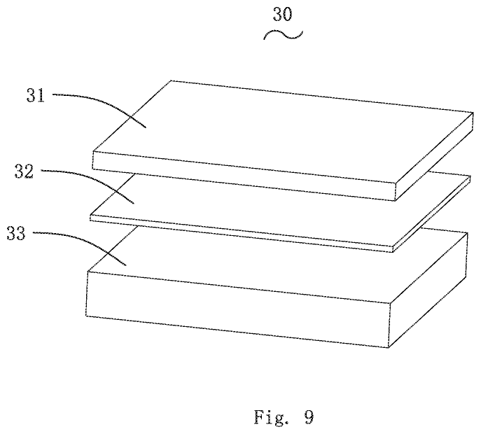

Referring to FIGS. 7 and 8, the second feed assembly 22 comprises a second feeding pin 221, a second feeding arm 222, and at least one second feeding tray(s) 223. The second feeding pin 221 is electrically connected with the external radio frequency front end, the second feeding arm 222 and the second feeding tray(s) 223, respectively. A front projection of the second feeding arm 222 on the plane array is located within the second gap 12 shown. A second feeding arm 222 is used to couple and feed the four radiators.

The second feeding trays 223 are annularly arranged at the second feeding pin 221 and is provided in parallel with the second feeding arm 222. The second feeding trays 223 are flaky. In the present embodiment, the second feeding trays 223 are in a circular shape. At least one second feeding tray(s) 223 are annularly arranged at the second feeding pin 221, the second feeding trays 223 and the second feeding pin 221 are electrically and fixedly connected, The axial direction of the second feeding pin 221 is perpendicular to each of the second feeding trays 223. When the second feeding tray 223 comprises a plurality of the second feeding trays, the plurality of second feeding trays 223 are spaced. In the present embodiment, the second feeding trays 223 comprise one second feeding tray 223 that is annularly arranged on the second feeding pin 221, and a second feeding tray 223 that is electrically connected with the second feeding pin 221. The first feeding trays 213 and the second feeding trays 223 can serve to expand the bandwidth.

The second feeding pin 221 is vertically connected with one end of the second feeding arm 222. The second feeding pin 221 comprises a fourth probe part 2212 connected with the second feeding arm 222 and a third probe part 2211 connected in series with the fourth probe part. Both the third probe part 2211 and the fourth probe part 2212 is in a cylindrical shape, and the diameter of the third probe part 2211 is larger than that of the fourth probe part 2212. At least one second feeding tray(s) 223 are annularly arranged on the fourth probe part 2212. The third probe part 2211 is electrically connected with the external radio frequency front end, and the fourth probe part 2212 is electrically connected with the second feeding arm 222. In the embodiment, the fourth probe part 2212 and one end of the second feeding arm 222 are connected.

The second feeding arm 222 is in a sheet shape, and the second feeding arm 222 is in a rectangular shape. In this embodiment, the second feeding arm 222 and the four radiators are located in different planes, i.e. the second feeding arm 222 is located in a plane between the plane array and the grounding sheet 40. The second feeding arm 222 comprises opposite first and second ends. The front projection of the first end of the second feeding arm 222 on the plane array is located between the first radiator 13 and the fourth radiator 16. The front projection of the second end of the second feeding arm 222 the plane array is positioned between the second radiator 14 and the third radiator 15.

Referring to FIG. 9, the substrate 30 comprises a first substrate 31, a second substrate 32, and a third substrate 33 on top of each other in order. The radiation part 10 and the first feeding arm 212 are provided on the same surface of the first substrate 31, and the second feeding arm 222 is provided on a surface of the first substrate 31 opposite to the first feeding arm 212. The second feeding arm is also provided on the surface of the second substrate 32 facing the first substrate 31. The second probe part 2112 is arranged threaded in the first substrate 31 and the second substrate 32, the fourth probe part 2212 is arranged threaded in the second substrate 32, the first probe part 2111 is arranged threaded in the third substrate 33. The third probe part is also arranged threaded in the third substrate 33. The grounding sheet 40 is provided on the surface of the third substrate 33 away from the radiation part 10. It is understood that holes (not shown) may be formed in the first substrate 31, the second substrate 32, and the third substrate 33. So that other elements, such as a feeding part 20 and a metal through hole 50 are threaded.

By adjusting the sizes of the first radiator 13, the second radiator 14, the third radiator 15, the fourth radiator 16, the first feeding trays 213 and the second feeding trays 223, the frequency band coverage of the antenna can be further increased.

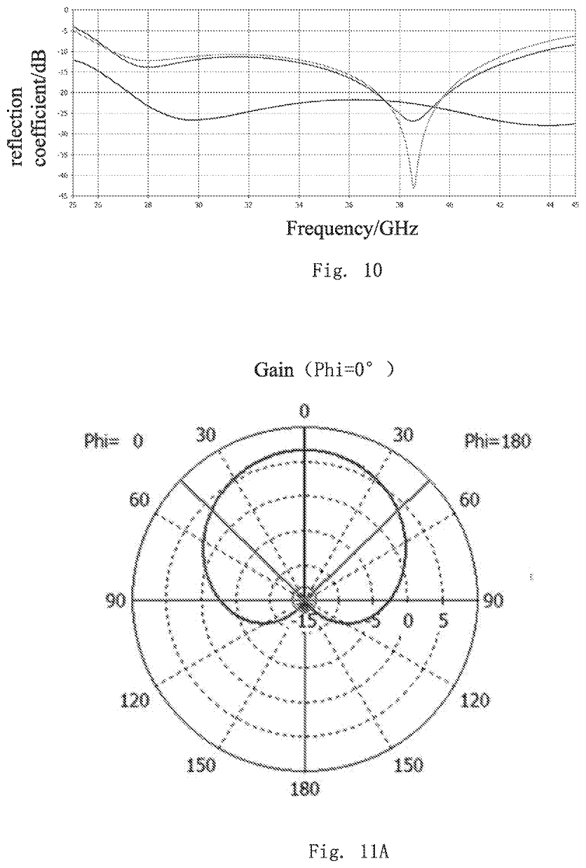

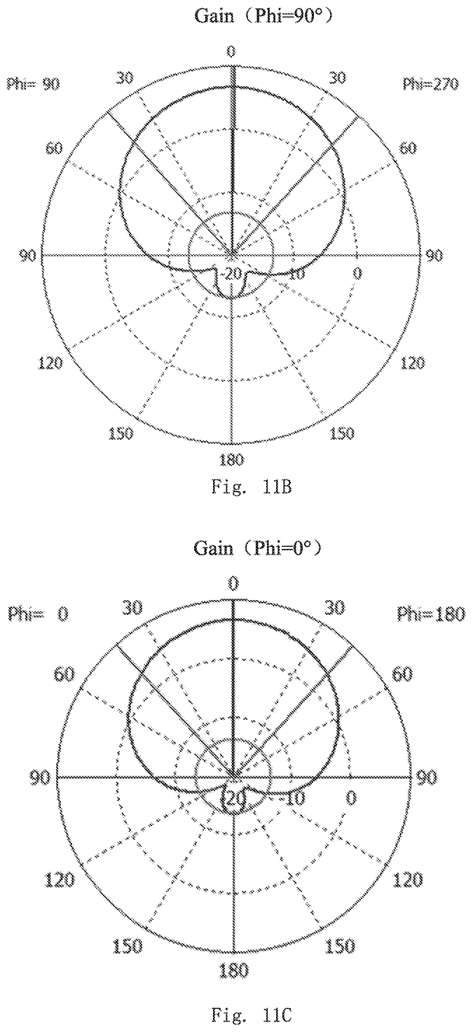

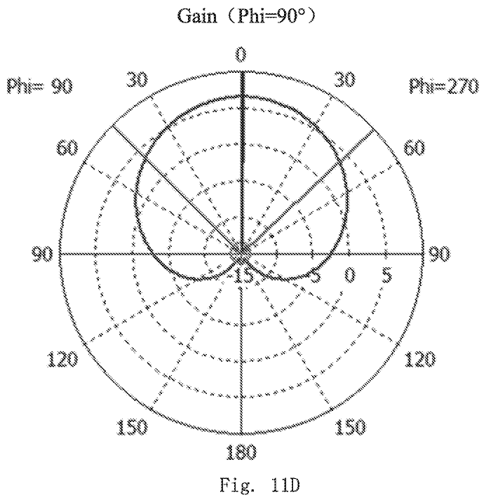

The performance of the antenna 1 can be seen in FIGS. 10, 11A, 11B, 11C, and 11D. The antenna 1 has a higher gain.

The invention also provides an electronic device comprising the antennal. The electronic device is an intelligent terminal or an antenna base station.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An antenna, comprising:
a radiation part having four radiators distributed in a 2×2 plane array, the radiators being spaced apart from each other for forming a first gap and a second gap perpendicular to the first gap at a center of the plane array;
a grounding sheet stacked on the radiation part;
a radiation part feeding the radiation part;
a feeding part comprising a first feeding pin, a first feeding arm, a second feeding pin and a second feeding arm;
a front projection of the first feeding arm on the plane array located in the first gap;
a front projection of the second feeding arm on the plane array located in the second gap; wherein
the second feeding arm is perpendicular to the first feeding arm; the first feeding pin is vertically connected with one end of the first feeding arm, and the second feeding pin is vertically connected with one end of the second feeding arm; the first feeding arm and the second feeding arm are respectively used for coupling and feeding the four radiators.

2. The antenna as described in claim 1, wherein the first feeding arm is located in a plane where the plane array is located, and the second feeding arm is located in a plane between the plane array and the grounding sheet.

3. The antenna as described in claim 1, wherein the first feeding pin comprises a second probe part connected with the first feeding arm and a first probe part connected in series with the second probe part; a diameter of the first probe part is larger than that of the second probe part, the feeding part further comprises at least one first feeding tray, and the at least one first feeding trays is annularly arranged on the second probe part and parallel to the first feeding arm.

4. The antenna as described in claim 3, wherein the first feeding trays comprises a plurality of feeding trays spaced from each other.

5. The antenna as described in claim 4, wherein the first feeding trays comprise four feeding trays.

6. The antenna as described in claim 1, wherein the second feeding pin comprises a fourth probe part connected with the second feeding arm and a third probe part connected in series with the fourth probe part; a diameter of the third probe part is larger than that of the fourth probe part; the feeding part further comprises at least one second feeding tray, and the at least one second feeding tray is annularly arranged on the fourth probe part and parallel to the second feeding arm.

7. The antenna as described in claim 6, wherein the second feeding trays comprise a plurality of feeding trays spaced from each other.

8. The antenna as described in claim 1, further comprising a substrate, the radiation part and the grounding sheet are respectively arranged on two opposite surfaces of the substrate; the first feeding pin, the second feeding pin is arranged threaded in the substrate.

9. The antenna as described in claim 1, further comprising a plurality of metal through holes, wherein each of the radiators is electrically connected with the grounding sheet through at least one metal through hole.

10. An electronic device, comprising an antenna as described in claim 1, wherein the electronic device is an intelligent terminal or an antenna base station.

11. An electronic device, comprising an antenna as described in claim 2, wherein the electronic device is an intelligent terminal or an antenna base station.

12. An electronic device, comprising an antenna as described in claim 3, wherein the electronic device is an intelligent terminal or an antenna base station.

13. An electronic device, comprising an antenna as described in claim 4, wherein the electronic device is an intelligent terminal or an antenna base station.

14. An electronic device, comprising an antenna as described in claim 5, wherein the electronic device is an intelligent terminal or an antenna base station.

15. An electronic device, comprising an antenna as described in claim 6, wherein the electronic device is an intelligent terminal or an antenna base station.

16. An electronic device, comprising an antenna as described in claim 7, wherein the electronic device is an intelligent terminal or an antenna base station.

17. An electronic device, comprising an antenna as described in claim 8, wherein the electronic device is an intelligent terminal or an antenna base station.

18. An electronic device, comprising an antenna as described in claim 9, wherein the electronic device is an intelligent terminal or an antenna base station.
